(19) United States
(12) Patent Application Publication
(10) Pub. No.: US 2020/0233977 A1
(43) Pub. Date: Jul. 23, 2020

(54) CLASSIFICATION AND MANAGEMENT OF PERSONALLY IDENTIFIABLE DATA

(71) Applicant: Microsoft Technology Licensing, LLC, Redmond, WA (US)

(72) Inventors: Ashutosh CHICKERUR, Sammamish, WA (US); Piyush JOSHI, Redmond, WA (US); Pouyan AMINIAN, Seattle, WA (US); Gustavo T. SEMENCATO, Redmond, WA (US); Leili POURNASSEH, Bellevue, WA (US); Pradeep Ayyappan NAIR, Bellevue, WA (US); Thomas William KEANE, Seattle, WA (US)

(73) Assignee: Microsoft Technology Licensing, LLC, Redmond, WA (US)

(21) Appl. No.: 16/252,320

(22) Filed: Jan. 18, 2019

(51) Int. Cl. G06F 21/62; G06F 16/28; G06F 16/22

(52) U.S. Cl. CPC G06F 21/6254; G06F 16/2255; G06F 16/285

(57) ABSTRACT

A computing system comprises a dataset including a plurality of data entries, at least some which include personally identifiable information (PII). A personal data oversight machine of the computing system is configured to receive an indication that a particular data entry includes PII, and based on the contents of the data entry, classify the data entry as including one or more of a plurality of types of PII by applying one or more data classification tags of a set of candidate data classification tags to the data entry. Based on the data classification tags applied to the data entry, the personal data oversight machine applies one of a set of data management tags to the data entry, the set of data management tags including deletion, retention, and anonymization tags, and based on the data management tag, applies a data management operation to the data entry.

### BACKGROUND

Many companies and other organizations maintain datasets including large amounts of user data, some of which may be usable to learn personal details or behaviors of human users. It is important that such data be securely stored and, when applicable, anonymized or deleted to comply with user wishes and applicable regulations.

### BRIEF DESCRIPTION OF THE DRAWINGS

FIG. 1 schematically depicts a dataset that includes various types of user data.

FIG. 2 illustrates an example method for classification and management of personally identifiable information (PII).

FIG. 3 illustrates an example dataset including PII.

FIGS. 4A and 4B schematically illustrate application of data classification and data management tags to a data entry including PII.

FIG. 5 schematically illustrates an anonymization operation applied to a data entry.

FIG. 6 schematically illustrates deletion of a user-specific salt.

FIG. 7 schematically illustrates deletion of a service-specific salt.

FIG. 8 schematically illustrates division of a data entry between a retention table and a reference table.

FIG. 9 schematically shows an example computing system.

### DETAILED DESCRIPTION

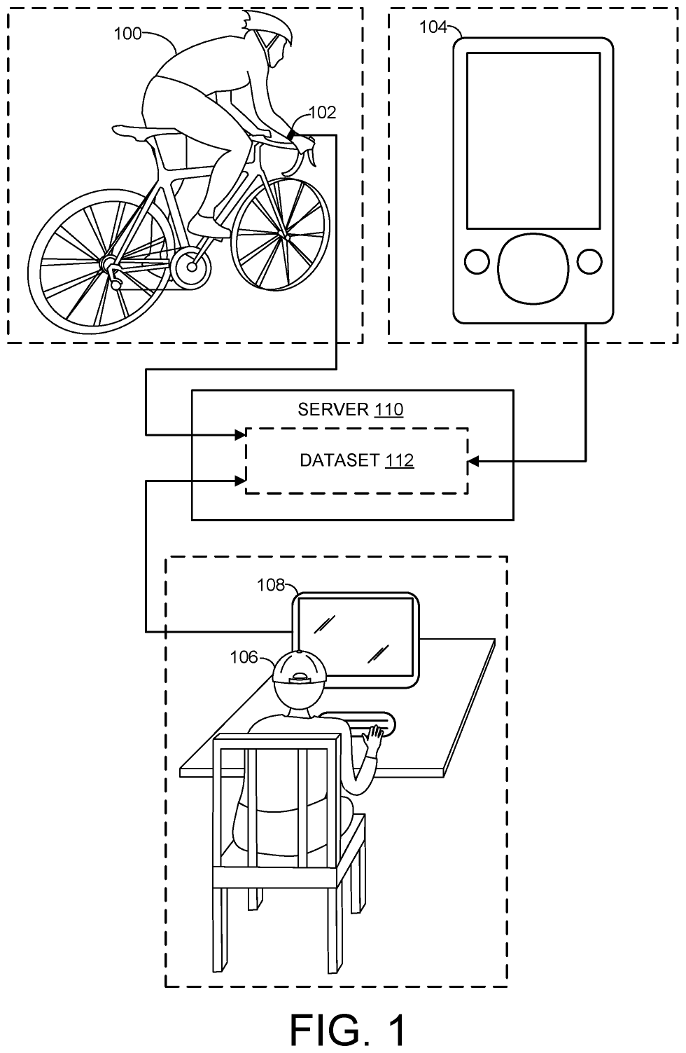

As discussed above, organizations may collect a variety of types of user data in various ways and for various reasons. This is schematically illustrated in FIG. 1, which shows a wearable computing device 102 (e.g., smart watch, fitness tracker) owned by a user 100, as well as a mobile computing device 104 (e.g., smartphone), and another user 106 using a desktop computer 108. Data from these various devices is transmitted to a server 110, which maintains a dataset 112 that includes a plurality of types of data maintained by an entity (e.g., individual, business, organization, government). Dataset 112 may include a diverse variety of data types, including data that is unrelated to the identities of the device users (e.g., non-identifying device diagnostic or telemetry data), as well as data that can be characterized as personally identifiable information (PII), such as the real names of human users, phone numbers, email addresses, a real-world location (e.g., from a GPS device or inferred based on IP address), social security numbers, etc.

Typical approaches for handling PII stored in such a manner are often substantially ad-hoc, involving manual curation of data held in spreadsheets or databases. Even in ideal scenarios, such ad-hoc approaches are inefficient and rely on significant manual effort while providing little to no transparency as to whether proper procedures are actually implemented. In less ideal scenarios, poor handling of PII, often due to poor policies or policy implementations, can lead to unintentional exposure of personal user data to unauthorized third parties. Numerous such exposures, some massive in scale, have signaled the increasingly significant need for organizations to handle PII in secure and transparent ways, and has led to some jurisdictions passing regulations governing the handling of PII.

Accordingly, the present disclosure is directed to a computing system that is configured to, upon receiving an indication that a particular data entry includes PII, apply one or more data classification tags to reflect the type of PII included in the data entry, and apply a data management tag appropriate to the data entry. Based on the data management tag, the computing system then applies a data management operation, such as a retention operation, an anonymization operation, or a deletion operation, to ensure that the data entry is handled in a way that is consistent with organizational policy and applicable regulations. For instance, after data has been held for a predetermined retention period, it may be deleted or anonymized in such a way as to make it difficult or impossible to link the data back to a particular person. A number of such anonymization approaches are described herein, and can result in the creation of pseudonymized data, unlinked pseudonymized data, or fully anonymized data. In this manner, the techniques described herein improve over conventional computerized approaches for handling PII maintained by an entity by increasing the security and transparency with which personal information is stored and managed.

Throughout the present disclosure, the data classification and management techniques described herein are primarily applied to PII taking the form of computer data in a dataset. As such, PII refers to any data that could be used to identify a person directly or indirectly, and includes, as nonlimiting examples, the person's real name, geographic location (or location history), phone number, email address, IP address, financial information, social security number, etc. Furthermore, the data classification and management techniques described herein may be applied to any suitable type of computer data, not just data including PII.

As discussed herein, data classification and management are performed on the basis of individual “data entries.” In a typical example, a data entry will take the form of a cell, row, or column in a spreadsheet or dataset, although this is a nonlimiting example. For instance, a data entry may include any number of individual pieces of information, such as a person's real name, the person's real name along with their email address, the real name, email address, and a phone number, etc. In other words, while a data entry will typically be one unit of a larger dataset, the data entry may include any suitable information, and may be formatted, stored, and accessed in any suitable way.

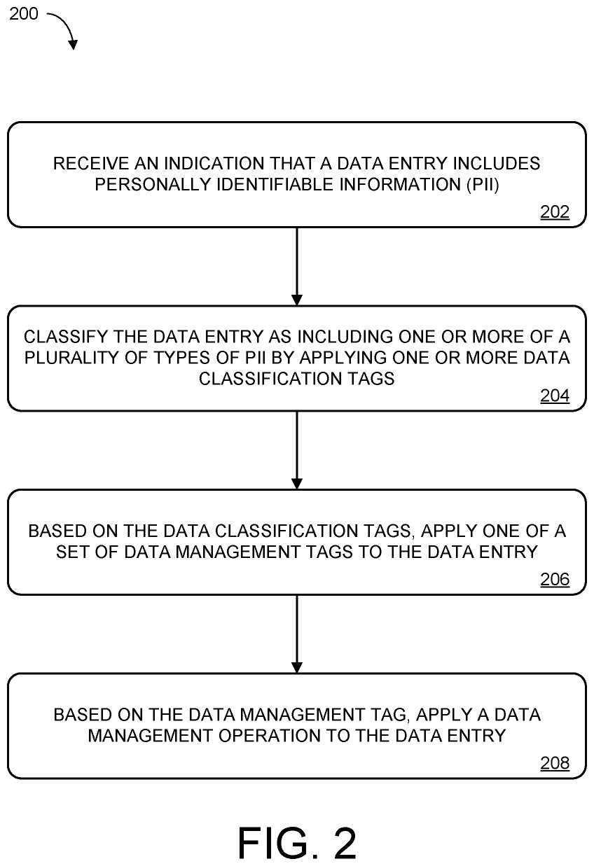

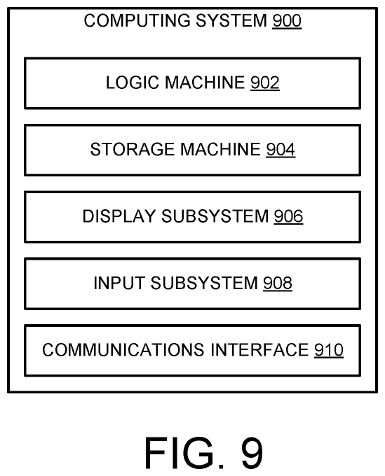

FIG. 2 illustrates an example method 200 for classifying and managing data entries including PII. Method 200 may be implemented on any computer hardware having any suitable form factor. As examples, method 200 may be implemented on a server computer; desktop computer; laptop; smartphone, tablet, or other mobile device; wearable device; VR/AR device; media center; etc. Method 200 may be implemented on computing system 900 described below with respect to FIG. 9. In particular, one or more steps of method 200 may be performed by a personal data oversight machine, which may be implemented as one or more logic machines and/or storage machines as is discussed below with respect to FIG. 9.

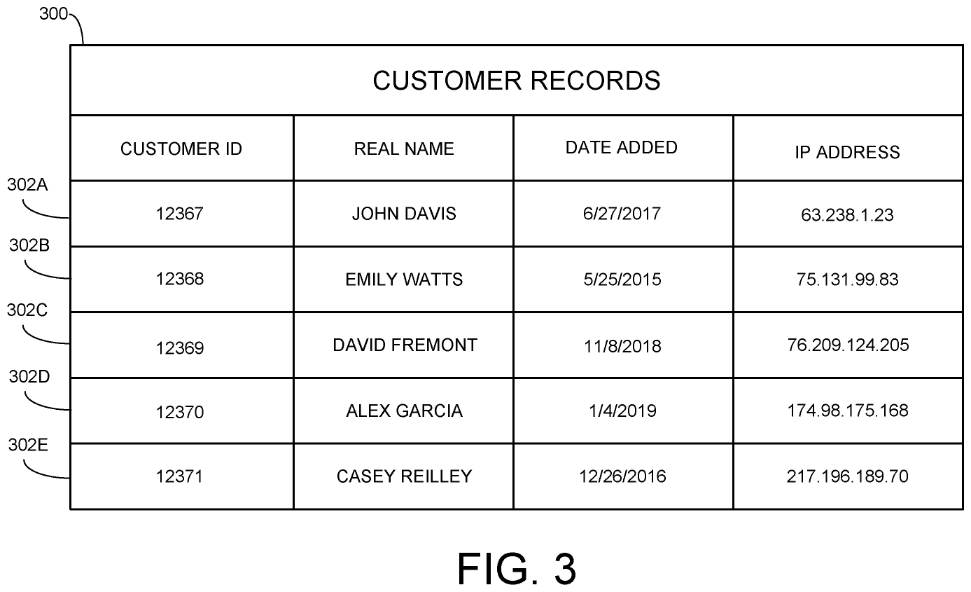

At 202, method 200 includes receiving an indication that a data entry includes PII. As discussed above, a data entry as described herein will typically be one unit of a larger dataset, which in turn may include a variety of different types of information. FIG. 3 shows an example dataset 300 including a plurality of data entries 302A-E. It will be understood that dataset 300 is presented as a nonlimiting example. Dataset 300 may be stored on a single computing device or distributed between a plurality of different computing devices that need not be physically near each other. Dataset 300 may be maintained by any suitable entity, including individuals, businesses, organizations, governments, etc.

In this example, the dataset is a table including customer records maintained by a business. Each data entry corresponds to a unique customer, and includes fields for the customer's ID number, real name, date added (e.g., a date of account registration or first purchase) and IP address (e.g., of a network-connected device that the customer uses to access a business website). However, in other examples the dataset may take any suitable form, and may include, as examples, financial records, location history, medical information, access logs, etc. Furthermore, in this example, each data entry corresponds to a row in the dataset, although in other examples data entries may take the form of columns, individual cells, or have another suitable form.

Notably, in FIG. 3, much of the information stored in dataset 300 includes PII. Specifically, each data entry 302A-E includes a person's real name, as well as the person's IP address, which can be used to infer the person's geographic location. Such PII may be indicated to the computing system (e.g., personal data oversight machine) in any suitable way. As one example, the computing system may include a list of previously-defined categories of information that are always classified as PII. An organization or other entity may then use a common set of categories to organize all the data that they collect to ensure that PII is appropriately identified and categorized. In another example, the personal data oversight machine may be configured to scan data entries in the dataset and automatically identify which data entries include PII. For instance, common types of PII that may be stored in a dataset often have distinctive formats (e.g., phone numbers, email addresses, credit card numbers), and the personal data oversight machine may be configured to automatically identify data entries having such formats as including PII, and/or flag such entries for manual review. Such scanning may in some cases use machine learning techniques, such as trained neural networks, to identify PII. Additionally, or alternatively, PII may be automatically identified as it is received, for instance based on a source of the data or associated metadata. In one example scenario, as a human user manually fills out a web form, any data that the user enters into fields that have been classified as PII (e.g., a real name field, a phone number field, an email address field) may automatically be classified as PII. Similarly, as a server receives telemetry or diagnostic information from a device, any data that is likely PII (e.g., an IP address or geographic location) may automatically be classified as such.

Returning to FIG. 2, at 204, method 200 includes, based on contents of the data entry, classifying the data entry as including one or more of a plurality of types of PII by applying one or more data classification tags. As discussed above, an organization or other entity may in some cases maintain a predefined list of the types of PII that they collect or may collect in the future. Thus, data classification tags may be selected from a set of candidate data classification tags. Such a set may include, as nonlimiting examples, a real-name tag, an email address tag, a phone number tag, a financial information tag, a geographic location tag, an IP address tag, and a social security number tag.

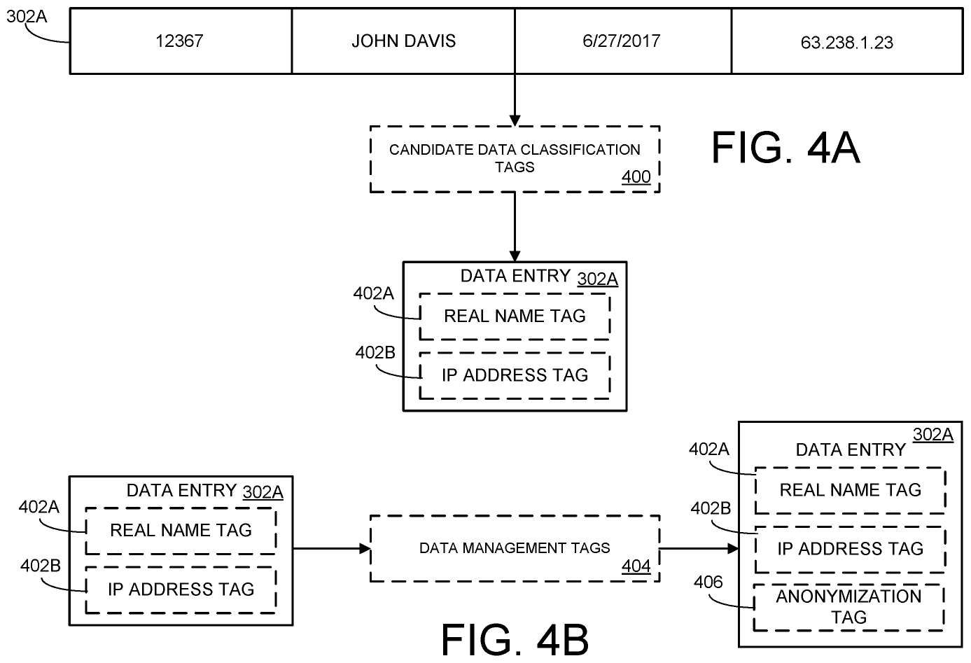

Tagging of a data entry is schematically illustrated in FIG. 4A, which again shows data entry 302A from FIG. 3. FIG. 4A also shows a set 400 of candidate data classification tags that, as discussed above, may in some cases include classification tags for each of the various types of PII collected by the entity that maintains dataset 300. Based on the contents of data entry 302A, the personal data oversight machine applies a real name data classification tag 402A and an IP address data classification tag 402B. The contents of the data entry may be evaluated in any suitable way. For instance, as discussed above, PII in a data entry may be automatically identified based on predefined categories that the data entry has been sorted into; identified based on distinctive formats of PII held in the data entry; identified by an automated analysis service such as a machine learning trained PII identifier; manually identified by a human user; flagged at time of receipt, etc.

The data classification tags may be applied or appended to the data entry in any suitable way. For instance, the data classification tags may be appended to the entire dataset as metadata, reflecting that individual rows, columns, cells, etc., include specific types of PII. As an alternative, the data tags may be added to the data entry as a new value or field—for instance, in FIG. 4A, a new column may be added to data entry 302A that includes the data classification tags that have been applied to the data entry. In some cases, the data tags may be maintained as a separate data structure that includes references to specific rows, columns, cells, etc., of a dataset that include PII.

Returning briefly to FIG. 2, at 206, method 200 includes, based on the one or more data classification tags applied to the data entry, applying one of a set of data management tags to the data entry. Different types of PII stored by an organization may, for example, have different requirements for proper handling. For instance, some types of PII may have more business value, be subject to different regulations, be subject to different treatment according to an organizational policy or user agreement, have pending anonymization or deletion requests from individual users, have pending retention requests from law enforcement, etc. A data management tag therefore serves to identify how a particular data entry should be handled based on the type of PII that the data entry includes and/or other applicable factors, such as user requests, available storage space, the age of the data entry, etc. As examples, the data management tags can include retention, deletion, and anonymization tags, indicating that applicable data entries should be retained, anonymized, or deleted respectively. For instance, it may be determined that the geographic distribution of a business's customers has more value than the real names of the customers, and thus any PII corresponding to real names may be fully anonymized or deleted, while PII corresponding to geographic information may be retained or de-identified. It will be understood, however, that data management tags may be applied according to any suitable criteria depending on an entity's unique circumstances, policies, userbase, etc.

Tagging of a data entry with a data management tag is schematically illustrated in FIG. 4B, which again shows data entry 302A after it has been tagged with data classification tags 402A and 402B. FIG. 4B also schematically shows a set of candidate data management tags 404, one of which is applied to data entry 302A as anonymization tag 406, indicating that all or part of the data entry should be anonymized to make it more difficult, if not impossible, to link the data entry back to a particular person. As discussed above with respect to the data classification tags, the data management tag may be applied in any suitable way (e.g., appended as metadata, stored in a separate data structure), and according to any suitable criteria.

As discussed herein, any and all data entries in a dataset having PII may be tagged with one or more data classification tags and a data management tag. Accordingly, in some examples, the personal data oversight machine may be configured to verify that each data entry in the dataset having PII has one or more data classification tags and a data management tag. This may be done for the sake of auditing the dataset—e.g., to prove compliance with internal policy or applicable regulations. Such verification may be done at any suitable time (e.g., in response to auditor request, on a set schedule) and for any suitable reason. Furthermore, such verification may involve examining any data entries known to include PII or flagged for potentially including PII, and/or may involve independently reevaluating every data entry in the dataset. In some examples, the personal data oversight machine may be configured to present the results of such verification in a dedicated user interface or portal, for instance breaking down the types of PII maintained in the dataset, as well as providing information as to how such data is classified and managed.

Returning again to FIG. 2, at 208, method 200 includes, based on the data management tag applied to the data entry, applying a data management operation to the data entry. The data management operation may take any suitable form. As nonlimiting examples, the data management operation may be one of a deletion operation, an anonymization operation, and a retention operation.

Furthermore, in some examples, the personal data oversight machine may be configured to, after a predetermined interval has elapsed, query a source of the data entry to verify that the data management operation was performed. This may be done to ensure that data management operations occur as scheduled and in compliance with policy, particularly in scenarios where PII data is distributed between a plurality of different devices and locations. For instance, at the end of a day, week, month, etc., the personal data oversight machine may be configured to attempt to access PII that was anonymized or deleted to ensure that such data is truly removed or otherwise inaccessible.

In one example scenario, an organizational policy may dictate that relatively new PII (e.g., less than thirty days old) may be retained, and then anonymized or deleted once the retention period is over. Accordingly, applying a retention data management tag (and thus indicating that the data entry should be retained) may include defining a retention period. Once the retention period has elapsed, the personal data oversight machine may be configured to reapply one of the set of data management tags to the data entry. For example, a new retention management tag may be applied that specifies a new retention period, or an anonymization or deletion tag may be applied. In some examples, during initial tagging of the data entry, two or more management tags may be applied, for instance to specify that the data entry should be anonymized or deleted once a retention period is over.

Applying a deletion data management operation may involve any number of computer operations that may be characterized as deletion. Depending on the scenario, deleted data may or may not be recoverable. For instance, deleting a data entry may simply involve removing a reference to the data entry (or individual fields of the data entry) from the dataset, in which case the PII may still be recoverable—e.g., from unallocated sector space of a hard drive. In other examples, however, the deletion operation may involve scrubbing PII from the computing system permanently, for instance by overwriting the storage media on which the PII was stored. Additionally, or alternatively, deleting the PII may involve deleting an encryption key used to encrypt the PII, in which case the data may be substantially unrecoverable.

With regard to anonymization data management operations, a variety of suitable processes may be used to transform PII into pseudonymized, unlinked pseudonymized, or fully anonymized data. In general, such operations are described herein as “de-identification,” and different de-identification operations may be applied to different types of PII. For instance, real names, and/or other common strings, may be hashed with a suitable hash function and salt, as will be described in more detail below. Geographic location data expressed as latitude/longitude coordinates may be deidentified by rounding the coordinates to a single decimal, at which point the location can only be resolved to an approximately six-mile grid location. For IP addresses, IPv4 addresses may be de-identified by removing the last octet (e.g., 10.10.10.10 becomes 10.10.10.0), while IPv6 addresses may be de-identified by removing the last set of hex groups. MAC addresses may be de-identified by removing the final two octets. Email addresses may be de-identified by removing the portion of the address before the domain name (e.g., john_doe@example.com becomes @example.com). International mobile equipment identity (IMEI) numbers may be de-identified by deleting the last five decimals.

For other types of PII in a dataset, full deletion may be preferable to de-identification via hashing or other means. For instance, a list of user-installed applications received from a device, user-generated content, search queries, voice data, and health and biometric data may be deleted, as such information may be difficult or impossible to sufficiently de-identify.

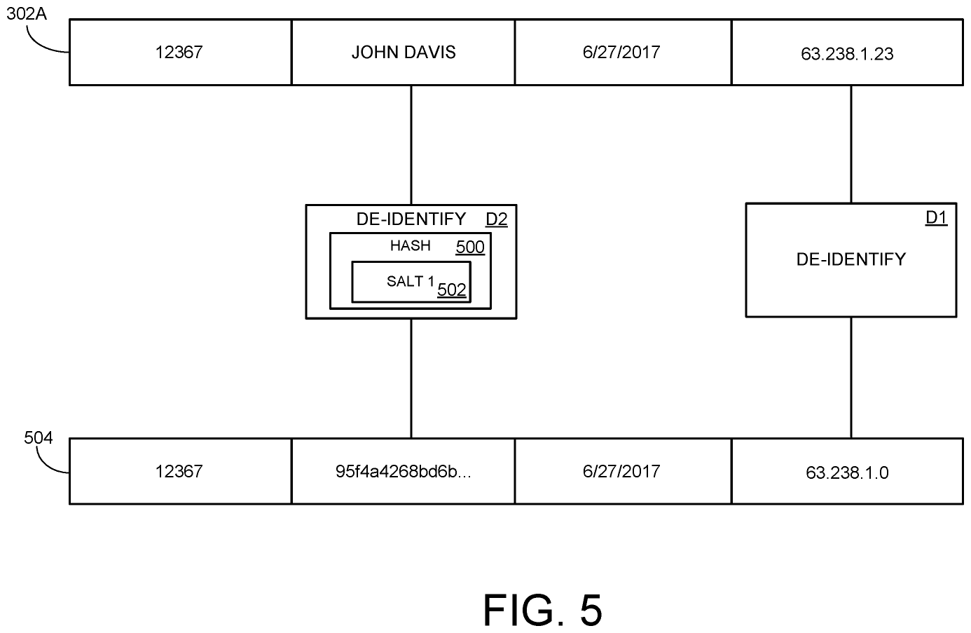

De-identification of PII in a data entry is schematically illustrated in FIG. 5, which again shows data entry 302A. As discussed above, data entry 302A includes two types of PII: a user's real name and the user's IP address. FIG. 5 also shows two different de-identification operations D1 and D2 used to de-identify the PII included in the data entry. Specifically, de-identification operation D1 is applied to the user's IP address. As discussed above, operation D1 de-identifies the IP address by removing the final octet of the address. Thus, the IP address 63.238.1.23 becomes 63.238.1.0, therefore preventing the de-identified IP address from being associated with any particular person.

Continuing with FIG. 5, de-identification operation D2 involves hashing the PII (in this case the person's real name) with a salt. In cryptography, a salt is random data that is used as an input when data, such as a password or PII, is hashed. Hashing, in turn, refers to a one-way function that transforms data of arbitrary size to an output string of a fixed size. By design, once data is hashed, it is difficult, if not impossible, to recreate the original data, particularly when the salt is not known. In FIG. 5, the user's real name is hashed with a hash function 500 that uses a salt 502. As an example, the hash function may be SHA256. Typically, the hash function will be SHA2 or stronger.

FIG. 5 also shows a de-identified data entry 504, which retains non-identifying information from data entry 302A. Specifically, de-identified data entry 504 still includes the customer ID and date added, which by themselves are not usable to identify any particular person without additional information. The PII included in data entry 302 has been de-identified, as the person's real name has been hashed and the IP address has been obfuscated. Thus, de-identified data entry 504 may be retained in the database while mitigating, if not completely removing, the risk that the data may be linked back to a particular person.

The specifics of de-identifying PII in a dataset via hash functions may vary from implementation to implementation. For example, in FIG. 5, the anonymization operation includes hashing the data entry with a random salt that is deleted after a predetermined interval. For example, data entries that are collected, processed, anonymized, etc., at the same time may be hashed with the same salt, and the salt may be retained for a predetermined interval. This interval may have any suitable length (e.g., 1 day, 30 days, 180 days, one year) depending on internal policy and applicable regulations. Once the predetermined interval has elapsed the salt may be deleted and replaced with a new salt, at which point any data hashed with the deleted salt may be significantly more difficult, if not impossible, to recover.

In alternate implementations, however, applying an anonymization data management operation may be done in other suitable ways, for instance by hashing a data entry with a user-specific salt that is stored in a lookup table. In other words, any and all PII associated with a particular user may be hashed with the same salt. Thus, the data may be pseudonymized, as it cannot on its own be linked back to a particular individual, although the identity of the individual may be uncovered with significant effort. However, after receiving a request to delete personal data associated with the user, the personal data oversight machine may be configured to delete the user-specific salt. At this point the data may take the form of unlinked pseudonymized data, as it may be substantially impossible without advanced and time-consuming analysis to recreate the original data.

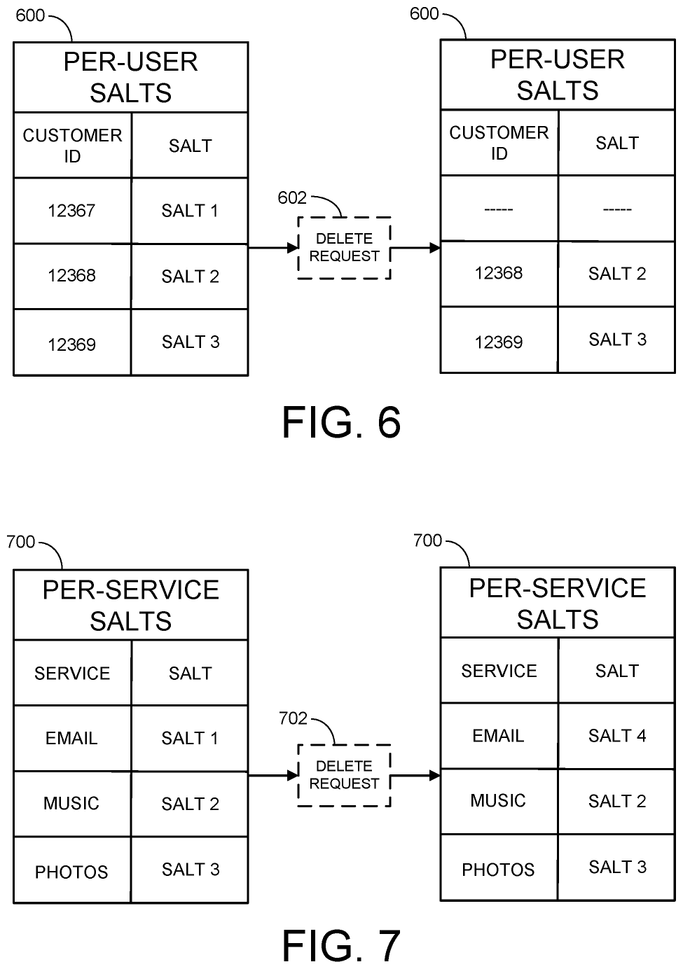

This is schematically illustrated in FIG. 6, which shows an example lookup table 600 including user-specific salts. Specifically, the table includes a list of user ID numbers, as well as salts that are specific to the various users. However, after receiving a request 602 to delete data maintained for a particular user (e.g., from the user, from a 3rd party, or according to a data retention schedule), the personal data oversight machine removes the entry in table 600 corresponding to the user. Thus, the user ID, as well as the salt used to hash PII associated with the user, is removed and the user's data becomes difficult, if not impossible to recreate. However, it will be understood that, in other scenarios, after receiving a deletion request, the user PII data may be deleted as discussed above, and not merely the user-specific hash.

As another alternative, applying an anonymization data management operation may include hashing the data entry with a service-specific salt stored in a lookup table. In contrast to the user-specific salt, a service-specific salt may be used for all user data collected as part of a specific service. For example, FIG. 7 shows an example lookup table 700 including the names of services offered by a particular entity (i.e., email, music, and photos), as well as service-specific salts for each service. However, as with the user-specific salts discussed above, a service-specific salt may be deleted after receiving a request 702 to delete personal data of a user associated with a data entry that was hashed with the service-specific salt. At this point, a new service-specific salt may be generated that is used to hash new data (e.g., corresponding to other users) collected as part of the service. In FIG. 7, after request 702 is received, the previous service-specific salt (“Salt 1”) is deleted and replaced with a new service-specific salt (“Salt 4”).

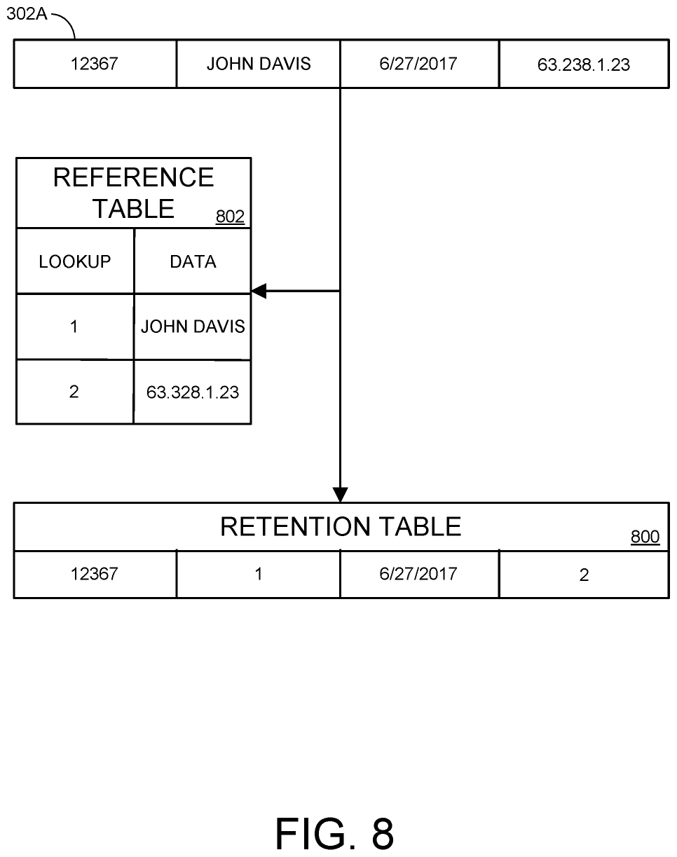

As another alternative, applying an anonymization data management operation may include dividing the data entry between a retention table and a reference table. The retention table includes a unique identifier for a user associated with the data entry, as well as one or more lookup values that represent PII originally found in the data entry. The reference table, by contrast, includes the lookup value as well as the PII that the lookup value replaced in the retention table. This is schematically illustrated in FIG. 8, which again shows data entry 302A. However, data in the data entry is divided between a retention table 800 and a reference table 802. Retention table 800 includes substantially the same information as data entry 302A, although the PII (user's real name and IP address) have been replaced with non-identifying lookup values “1” and “2.” Thus, the retention table cannot be used on its own to identify the user. Reference table 802, by contrast, includes the lookup values as well as the PII that they represent. Thus, the user's personal information may only be exposed if both the retention and reference tables are accessed. To mitigate this, access criteria associated with the reference table may in some cases be more strict than access criteria associated with the retention table. Upon receiving a request to delete personal data associated with the user, the reference table, and/or specific entries in the reference table corresponding to the user, may be deleted. This will leave only the de-identified data stored in the retention table.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 900 that can enact one or more of the methods and processes described above. Computing system 900 is shown in simplified form. Computing system 900 may take the form of one or more personal computers, server computers, tablet computers, home-entertainment computers, network computing devices, gaming devices, mobile computing devices, mobile communication devices (e.g., smart phone), and/or other computing devices.

Computing system 900 includes a logic machine 902 and a storage machine 904. Computing system 900 may optionally include a display subsystem 906, input subsystem 908, communication subsystem 910, and/or other components not shown in FIG. 9.

Logic machine 902 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 904 includes one or more physical devices configured to hold instructions executable by the logic machine to implement the methods and processes described herein. When such methods and processes are implemented, the state of storage machine 904 may be transformed—e.g., to hold different data.

Storage machine 904 may include removable and/or built-in devices. Storage machine 904 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 904 may include volatile, nonvolatile, dynamic, static, read/write, read-only, random-access, sequential-access, location-addressable, file-addressable, and/or content-addressable devices.

It will be appreciated that storage machine 904 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 902 and storage machine 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example. In some examples, one or both of logic machine 902 and storage machine 904 may implement a personal data oversight machine, as discussed above.

The terms “module,” “program,” and “engine” may be used to describe an aspect of computing system 900 implemented to perform a particular function. In some cases, a module, program, or engine (e.g., personal data oversight machine) may be instantiated via logic machine 902 executing instructions held by storage machine 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 906 may be used to present a visual representation of data held by storage machine 904. This visual representation may take the form of a graphical user interface (GUI). As the herein described methods and processes change the data held by the storage machine, and thus transform the state of the storage machine, the state of display subsystem 906 may likewise be transformed to visually represent changes in the underlying data. Display subsystem 906 may include one or more display devices utilizing virtually any type of technology. Such display devices may be combined with logic machine 902 and/or storage machine 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 910 may be configured to communicatively couple computing system 900 with one or more other computing devices. Communication subsystem 910 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

In an example, a computing system comprises: a dataset including a plurality of data entries, at least some of the data entries including personally identifiable information (PII); and a personal data oversight machine configured to: receive an indication that a particular data entry includes PII; based on contents of the data entry, classify the data entry as including one or more of a plurality of types of PII by applying one or more data classification tags of a set of candidate data classification tags to the data entry; based on the one or more data classification tags applied to the data entry, apply one of a set of data management tags to the data entry, the set of data management tags including deletion, retention, and anonymization tags; and based on the data management tag applied to the data entry, apply a data management operation to the data entry. In this example or any other example, the data management operation is one of a deletion operation, a retention operation, or an anonymization operation. In this example or any other example, the anonymization operation includes hashing the data entry with a random salt that is deleted after a predetermined interval. In this example or any other example, the anonymization operation includes hashing the data entry with a user-specific salt stored in a lookup table. In this example or any other example, the personal data oversight machine is further configured to, after receiving a request to delete personal data associated with the user, delete the user-specific salt. In this example or any other example, the anonymization operation includes hashing the data entry with a service-specific salt stored in a lookup table. In this example or any other example, the personal data oversight machine is further configured to, after receiving a request to delete personal data of a user associated with the data entry, delete the service-specific salt and generate a new service-specific salt. In this example or any other example, the anonymization operation includes dividing the data entry between a retention table and a reference table, such that the retention table includes a unique identifier for a user associated with the data entry and a lookup value that anonymously represents the PII, and the reference table includes the lookup value and the PII, and where access criteria associated with the reference table are more strict than access criteria associated with the retention table. In this example or any other example, the personal data oversight machine is further configured to scan data entries in the dataset and automatically identify which data entries include PII. In this example or any other example, the personal data oversight machine is further configured to verify that each data entry including PII has one or more data classification tags and a data management tag. In this example or any other example, the personal data oversight machine is further configured to, after a predetermined interval has elapsed, query a source of the data entry to verify that the data management operation was performed. In this example or any other example, the set of candidate data classification tags includes one or more of a real-name tag, an email address tag, a phone number tag, a financial information tag, a geographic location tag, an IP address tag, and a social security number tag. In this example or any other example, applying the retention data management tag includes defining a retention period during which the data entry should be retained. In this example or any other example, the personal data oversight machine is further configured to, after the retention period has elapsed, reapply one of the set of data management tags to the data entry.

In an example, a method comprises: receiving an indication that a data entry includes personally identifiable information (PII), the data entry included in a dataset that includes a plurality of data entries; based on contents of the data entry, classifying the data entry as including one of a plurality of types of PII by applying one or more data classification tags from a set of candidate data classification tags to the data entry; based on the one or more data classification tags applied to the data entry, applying one of a set of data management tags to the data entry, the set of data management tags including deletion, retention, and anonymization tags; and based on the data management tag applied to the data entry, applying a data management operation to the data entry. In this example or any other example, the data management operation is an anonymization operation and includes hashing the data entry with a random salt that is deleted after a predetermined interval. In this example or any other example, the data management operation is an anonymization operation and includes hashing the data entry with a user-specific salt stored in a lookup table. In this example or any other example, the data management operation is an anonymization operation and includes hashing the data entry with a service-specific salt stored in a lookup table. In this example or any other example, the data management operation is an anonymization operation and includes dividing the data entry between a retention table and a reference table, such that the retention table includes a unique identifier for a user associated with the data entry and a lookup value that anonymously represents the PII, and the reference table includes the lookup value and the PII, and where access criteria associated with the reference table are more strict than access criteria associated with the retention table.

In an example, a computing system comprises: a dataset including a plurality of data entries, at least some of the data entries including personally identifiable information (PII); and a personal data oversight machine configured to: receive an indication that a particular data entry includes PII; based on contents of the data entry, classify the data entry as including one or more of a plurality of types of PII by applying one or more data classification tags from a set of candidate data classification tags to the data entry, the set of candidate data classification tags including one or more of a real-name tag, an email address tag, a phone number tag, a financial information tag, a geographic location tag, an IP address tag, and a social security number tag; based on the one or more data classification tags applied to the data entry, apply an anonymization data management tag to the data entry; and based on the anonymization data management tag applied to the data entry, apply an anonymization operation by hashing the data entry with a user-specific salt stored in a lookup table.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a dataset including a plurality of data entries, at least some of the data entries including personally identifiable information (PII); and
a personal data oversight machine configured to:
receive an indication that a particular data entry includes PII;
based on contents of the data entry, classify the data entry as including one or more of a plurality of types of PII by applying one or more data classification tags of a set of candidate data classification tags to the data entry;
based on the one or more data classification tags applied to the data entry, apply one of a set of data management tags to the data entry, the set of data management tags including deletion, retention, and anonymization tags; and
based on the data management tag applied to the data entry, apply a data management operation to the data entry.

2. The computing system of claim 1, where the data management operation is one of a deletion operation, a retention operation, or an anonymization operation.

3. The computing system of claim 2, where the anonymization operation includes hashing the data entry with a random salt that is deleted after a predetermined interval.

4. The computing system of claim 2, where the anonymization operation includes hashing the data entry with a user-specific salt stored in a lookup table.

5. The computing system of claim 4, where the personal data oversight machine is further configured to, after receiving a request to delete personal data associated with the user, delete the user-specific salt.

6. The computing system of claim 2, where the anonymization operation includes hashing the data entry with a service-specific salt stored in a lookup table.

7. The computing system of claim 6, where the personal data oversight machine is further configured to, after receiving a request to delete personal data of a user associated with the data entry, delete the service-specific salt and generate a new service-specific salt.

8. The computing system of claim 2, where the anonymization operation includes dividing the data entry between a retention table and a reference table, such that the retention table includes a unique identifier for a user associated with the data entry and a lookup value that anonymously represents the PII, and the reference table includes the lookup value and the PII, and where access criteria associated with the reference table are more strict than access criteria associated with the retention table.

9. The computing system of claim 1, where the personal data oversight machine is further configured to scan data entries in the dataset and automatically identify which data entries include PII.

10. The computing system of claim 9, where the personal data oversight machine is further configured to verify that each data entry including PII has one or more data classification tags and a data management tag.

11. The computing system of claim 1, where the personal data oversight machine is further configured to, after a predetermined interval has elapsed, query a source of the data entry to verify that the data management operation was performed.

12. The computing system of claim 1, where the set of candidate data classification tags includes one or more of a real-name tag, an email address tag, a phone number tag, a financial information tag, a geographic location tag, an IP address tag, and a social security number tag.

13. The computing system of claim 1, where applying the retention data management tag includes defining a retention period during which the data entry should be retained.

14. The computing system of claim 13, where the personal data oversight machine is further configured to, after the retention period has elapsed, reapply one of the set of data management tags to the data entry.

15. A method, comprising:
receiving an indication that a data entry includes personally identifiable information (PII), the data entry included in a dataset that includes a plurality of data entries;
based on contents of the data entry, classifying the data entry as including one of a plurality of types of PII by applying one or more data classification tags from a set of candidate data classification tags to the data entry;
based on the one or more data classification tags applied to the data entry, applying one of a set of data management tags to the data entry, the set of data management tags including deletion, retention, and anonymization tags; and
based on the data management tag applied to the data entry, applying a data management operation to the data entry.

16. The method of claim 15, where the data management operation is an anonymization operation and includes hashing the data entry with a random salt that is deleted after a predetermined interval.

17. The method of claim 15, where the data management operation is an anonymization operation and includes hashing the data entry with a user-specific salt stored in a lookup table.

18. The method of claim 15, where the data management operation is an anonymization operation and includes hashing the data entry with a service-specific salt stored in a lookup table.

19. The method of claim 15, where the data management operation is an anonymization operation and includes dividing the data entry between a retention table and a reference table, such that the retention table includes a unique identifier for a user associated with the data entry and a lookup value that anonymously represents the PII, and the reference table includes the lookup value and the PII, and where access criteria associated with the reference table are more strict than access criteria associated with the retention table.

20. A computing system, comprising:
a dataset including a plurality of data entries, at least some of the data entries including personally identifiable information (PII); and
a personal data oversight machine configured to:
receive an indication that a particular data entry includes PIT;
based on contents of the data entry, classify the data entry as including one or more of a plurality of types of PII by applying one or more data classification tags from a set of candidate data classification tags to the data entry, the set of candidate data classification tags including one or more of a real-name tag, an email address tag, a phone number tag, a financial information tag, a geographic location tag, an IP address tag, and a social security number tag;
based on the one or more data classification tags applied to the data entry, apply an anonymization data management tag to the data entry; and
based on the anonymization data management tag applied to the data entry, apply an anonymization operation by hashing the data entry with a user-specific salt stored in a lookup table.
